(19) United States
(12) Patent Application Publication
(10) Pub. No.: US 2026/0036804 A1
(43) Pub. Date: Feb. 5, 2026

(54) EXTENDED REALITY HEADSET ASSEMBLY WITH PANCAKE LENS ASSEMBLIES AND METHOD OF ASSEMBLING SAME

(71) Applicant: Raytrx, LLC, Tulsa, OK (US)

(72) Inventors: Michael A. H. Freeman, J.D., Tulsa, OK (US); Mitchael C. Freeman, Tulsa, OK (US); Jordan Boss, Tulsa, OK (US); Montgomery Freeman, Tulsa, OK (US); Victoria McArtor, Tulsa, OK (US); Simon Prosser, Tulsa, OK (US); Benham Rafiee, Tulsa, OK (US); Dillon Cornell, Tulsa, OK (US); Ian Oswald, Tulsa, OK (US); David Kessler, Tulsa, OK (US); Steven Von der Porten, Tulsa, OK (US)

(21) Appl. No.: 19/288,862

(22) Filed: Aug. 1, 2025

Related U.S. Application Data
(60) Provisional application No. 63/679,015, filed on Aug. 2, 2024.

(51) Int. Cl. G02B 23/18; G02B 7/12; G02B 13/00

(52) U.S. Cl. CPC G02B 23/18; G02B 7/12; G02B 13/0015; G02B 13/009

(57) ABSTRACT

An extended reality (XR) headset assembly is described herein. The XR headset assembly includes a headset adapted to be worn by a user and a display system. The display system includes an imaging equipment housing that is coupled to the headset and a pair of pancake lens assemblies extending from a bottom outer surface of the imaging equipment housing. The pair of pancake lens assemblies includes a left-eye pancake lens assembly positioned adjacent a left eye of the user and a right-eye pancake lens assembly positioned adjacent a right eye of the user. Each pancake lens assembly is pivotably coupled to the support frame and includes a lens housing containing an image generator and an imaging lens assembly positioned between the image generator and the user's eye along an optical axis.

### CROSS REFERENCE TO RELATED APPLICATIONS

This application claims the benefit of U.S. Provisional Application Ser. No. 63/679,015, filed Aug. 2, 2024, the disclosures of which are hereby incorporated by reference in their entirety.

### TECHNICAL FIELD

The present disclosure generally relates to wearable display apparatus and more particularly to a wearable display device that provides augmented reality (AR), mixed reality (MR), and extended reality (XR) viewing including pancake lens assemblies.

### BACKGROUND

Virtual image display has advantages for augmented reality (AR) presentation, including providing the capability for display of image content using a compact optical system that can be mounted on eyeglasses or goggles, generally positioned very close to the eye (Near-Eye Display) and allowing see-through vision, not obstructing the view of the outside world. Among virtual image display solutions for AR viewing are catadioptric optics that employ a partially transmissive curved mirror for directing image-bearing light to the viewer's eye and a partially reflective beam splitter for combining light generated at a 2D display with the real-world visible scene which forms a 3D image when viewed binocularly.

Vision correction applications have employed wearable display devices in order to enhance or compensate for loss of vision over portions of a subject's field of view (FOV). Support for these types of applications can require additional components and can introduce various factors related to wearability and usability that contribute to the overall complexity of the optical design and packaging.

Among challenges that must be addressed with wearable AR devices is obtaining sufficient brightness of the virtual image. The brightness may come from an image generator such as a Micro-OLED microdisplay (Self-luminous), LCOS (Reflective LCD), LCD (Transmissive LCD), or Micro-LED (Self-luminous) types of displays. Alternatively, Digital Light Processing (DLP) technologies may be used, or Laser Beam Splitting (LBS) techniques may be used. These may employ the techniques of Tunable-Polychromatic LEDs, Chip-first active-matrix micro LED displays using low temperature OTFT backplanes, or High PPI microLED displays with QD colour conversion.

Many types of AR systems, particularly those using pupil expansion, have reduced brightness and power efficiency. Measured in NITS or candelas per square meter (Cd/m2), brightness for the augmented imaging channel must be sufficient for visibility under some demanding conditions, such as visible when overlaid against a bright outdoor scene. Other optical shortcomings of typical AR display solutions include distortion, reduced see-through transmission, small eye box, and angular field of view (FOV) constraints.

Some types of AR solution employ pupil expansion as a technique for enlarging the viewer eye-box. However, pupil expansion techniques tend to overfill the viewer pupil which wastes light, providing reduced brightness, compromised resolution, and lower overall image quality.

Challenging physical and dimensional constraints with wearable AR apparatus include limits on component size, circuit board size, and positioning and, with many types of optical systems, the practical requirement for folding the optical path in order that the imaging system components be ergonomically disposed, unobtrusive, and aesthetically acceptable in appearance. Among aesthetic aspects, compactness is desirable, with larger horizontal than vertical dimensions.

Other practical considerations relate to positioning of the display components themselves. Organic Light-Emitting Diode (OLED) displays have a number of advantages for brightness and overall image quality, but can generate perceptible amounts of heat, which may have to be exhausted or minimized with heat sinks. For this reason, it is advisable to provide some distance and air space between an OLED display and the skin, particularly since it may be necessary to position these devices near the viewer's forehead or temples.

Still other considerations relate to differences between users of the wearable display, such as with respect to inter-pupil distance (IPD) and other variables related to the viewer's vision. Further, problems related to conflict between vergence depth and accommodation have not been adequately understood or addressed in the art.

It has proved challenging to wearable display designers to provide the needed image quality, while at the same time allowing the wearable display device to be comfortable and aesthetically pleasing and to allow maximum see-through and peripheral visibility, which distinguishes the model from virtual reality (VR). In addition, the design of system optics must allow wearer comfort in social situations, without awkward appearance that might discourage use in public. Providing suitable component housing for wearable eyeglass display devices has proved to be a challenge, making some compromises necessary. As noted previously, in order to meet ergonomic and other practical requirements, some folding of the optical path along one or both vertical and horizontal axes may be desirable.

The present invention addresses one or more of the aforementioned challenges.

### SUMMARY OF INVENTION

The Applicant's address the problem of advancing the art of AR/MR/XR display and addressing shortcomings of other proposed solutions, as outlined previously in the background section.

In one aspect of the present invention, an extended reality (XR) headset assembly is provided. The XR headset assembly includes a headset adapted to be worn by a user and a display system. The headset includes a support frame including a pair of opposing support arms extending along a longitudinal axis and spaced along a transverse axis perpendicular to the longitudinal axis. The display system is coupled to the support frame and includes an imaging equipment housing that is coupled to a forward portion of the support frame and positioned adjacent a forehead of the user, and a pair of pancake lens assemblies extending from a bottom outer surface of the imaging equipment housing and spaced along the transverse axis. The pair of pancake lens assemblies includes a left-eye pancake lens assembly positioned adjacent a left eye of the user and a right-eye pancake lens assembly positioned adjacent a right eye of the user. Each pancake lens assembly is pivotably coupled to the support frame and includes a lens housing containing an image generator and an imaging lens assembly positioned between the image generator and the user's eye along an optical axis. A controller is housed within the imaging equipment housing and includes one or more processors coupled to the pancake lens assemblies and programmed to display computer-generated images on the pancake lens assemblies.

In another aspect of the present invention, a display system for use with an XR headset assembly is provided. The XR headset assembly includes a headset adapted to be worn by a user and including a support frame including a pair of opposing support arms extending along a longitudinal axis and spaced along a transverse axis perpendicular to the longitudinal axis. The display system includes an imaging equipment housing that is coupled to a forward portion of the support frame and positioned adjacent a forehead of the user, and a pair of pancake lens assemblies extending from a bottom outer surface of the imaging equipment housing and spaced along the transverse axis. The pair of pancake lens assemblies includes a left-eye pancake lens assembly positioned adjacent a left eye of the user and a right-eye pancake lens assembly positioned adjacent a right eye of the user. Each pancake lens assembly is pivotably coupled to the support frame and includes a lens housing containing an image generator and a imaging lens assembly positioned between the image generator and the user's eye along an optical axis. A controller is housed within the imaging equipment housing and includes one or more processors coupled to the pancake lens assemblies and programmed to display computer-generated images on the pancake lens assemblies.

### BRIEF DESCRIPTION OF THE DRAWINGS

Non-limiting and non-exhaustive embodiments of the present invention are described with reference to the following figures. Other advantages of the present disclosure will be readily appreciated, as the same becomes better understood by reference to the following detailed description when considered in connection with the accompanying drawings wherein:

FIGS. 1-4 are perspective views of an extended reality (XR) headset assembly including pancake lens assemblies, according to embodiments of the present invention;

FIG. 5 is a side view of the XR headset assembly with the pancake lens assemblies in a deployed position;

FIG. 6 is a side view of the XR headset assembly with the pancake lens assemblies in a stowed position;

FIGS. 7 and 8 are perspective views of the XR headset assembly with portions of the housing removed;

FIG. 9 is a functional block diagram of the XR headset assembly;

FIGS. 10-13 are partial perspective views of the XR headset including a rechargeable protected battery pack assembly;

FIGS. 14-15 are partial perspective views of the XR headset including an inter-pupil distance (IPD) adjustment system; and

FIGS. 16-18 are perspective views of a pancake lens assembly that is used with the XR headset assembly, according to embodiments of the present invention.

Corresponding reference characters indicate corresponding parts throughout the drawings.

### DETAILED DESCRIPTION

With reference to the drawings, and in operation, the present invention is directed towards an extended reality (XR) headset including pancake lens assemblies that may be worn by a user. The following is a detailed description of the preferred embodiments of the disclosure, reference being made to the drawings in which the same reference numerals identify the same elements of structure in each of the several figures.

While the devices and methods have been described with a certain degree of particularity, it is to be noted that many modifications may be made in the details of the construction and the arrangement of the devices and components without departing from the spirit and scope of this disclosure. It is understood that the devices and methods are not limited to the embodiments set forth herein for purposes of exemplification. It will be apparent to one having ordinary skill in the art that the specific detail need not be employed to practice according to the present disclosure. In other instances, well-known materials or methods have not been described in detail in order to avoid obscuring the present disclosure.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, or characteristics may be combined in any suitable combinations and/or sub-combinations in one or more embodiments or examples.

Several (or different) elements discussed herein and/or claimed are described as being “coupled,” “in communication with,” “integrated,” or “configured to be in communication with” or a “system” or “subsystem” thereof. This terminology is intended to be non-limiting and, where appropriate, be interpreted to include, without limitation, wired and wireless communication using any one or a plurality of a suitable protocols, as well as communication methods that are constantly maintained, are made on a periodic basis, and/or made or initiated on an as-needed basis.

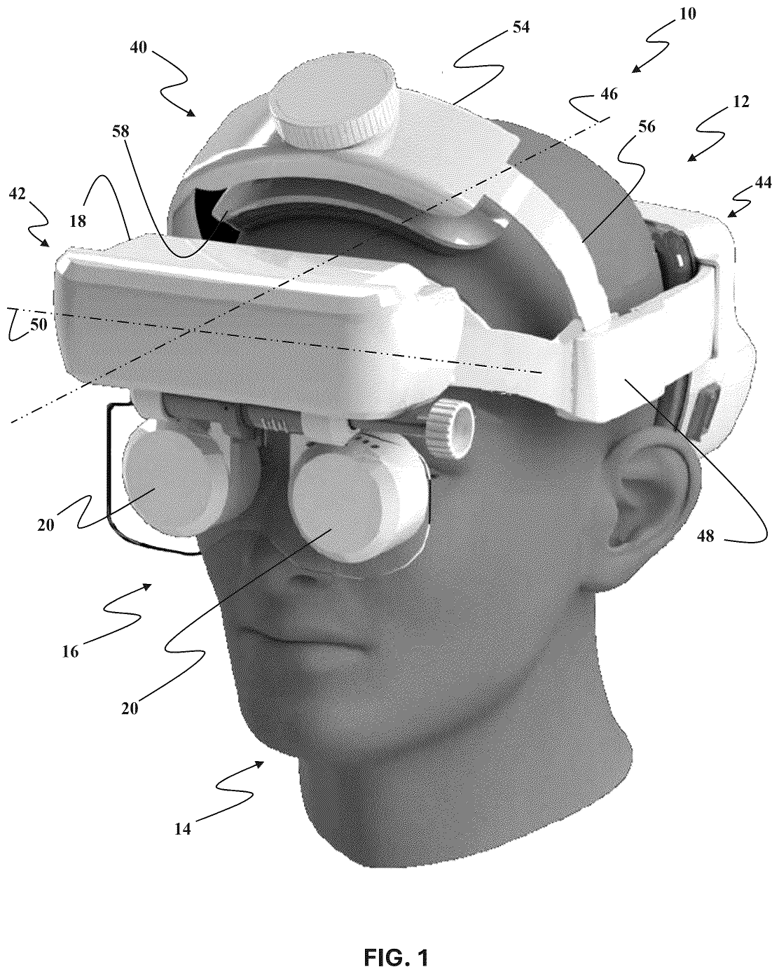

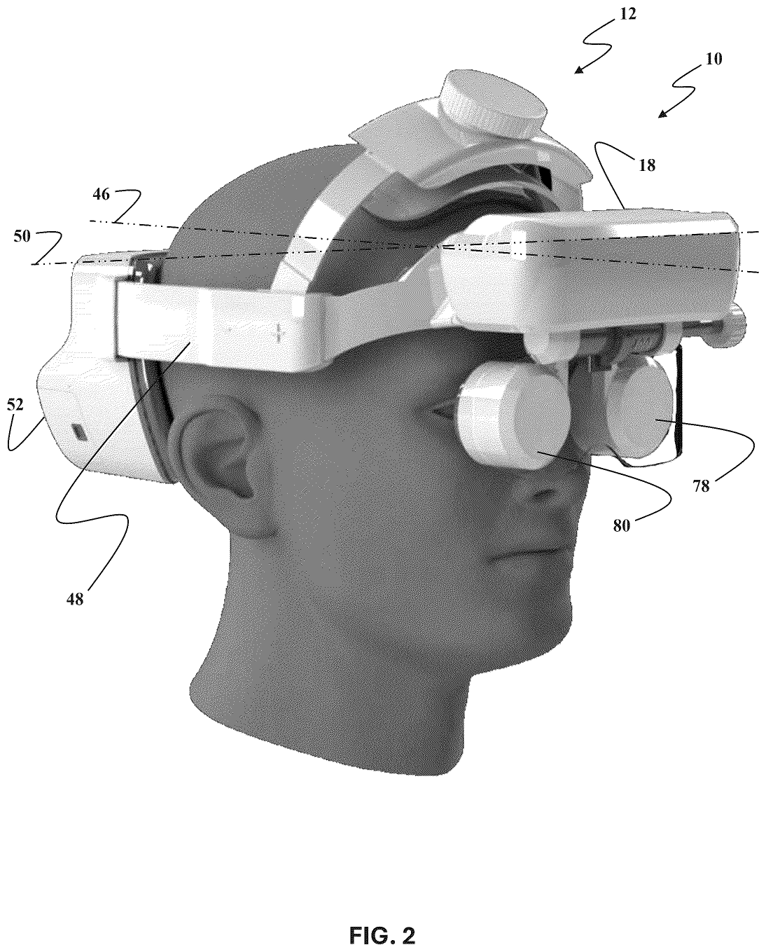

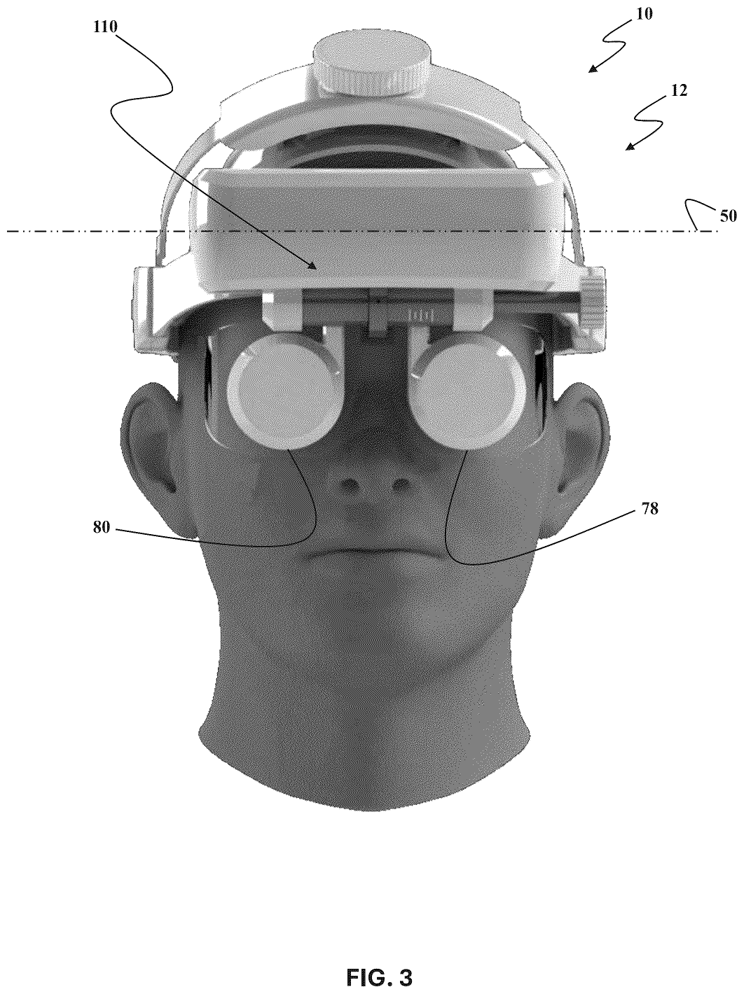

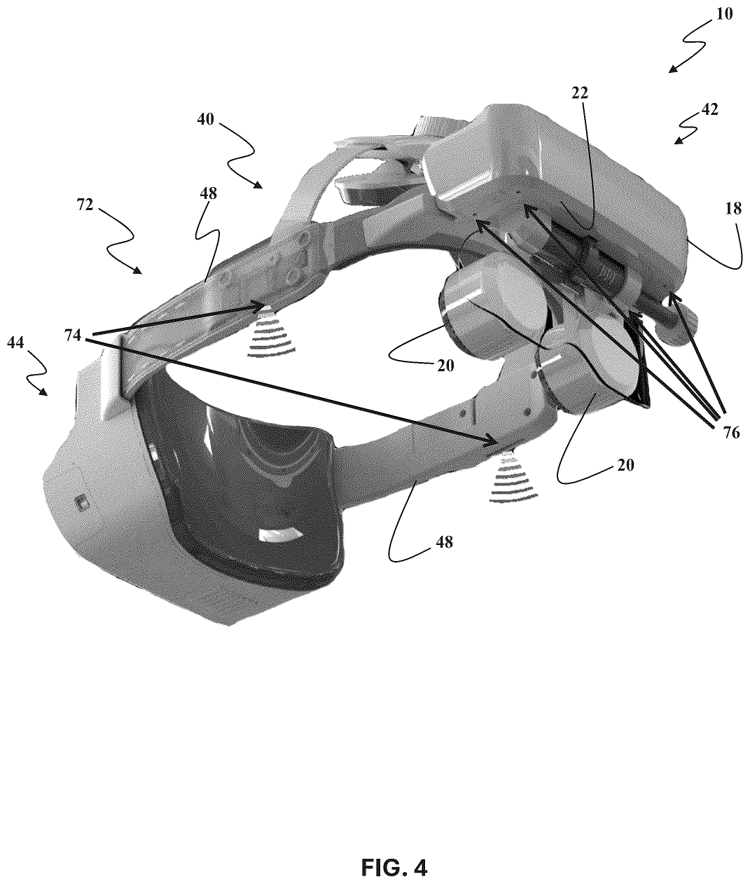

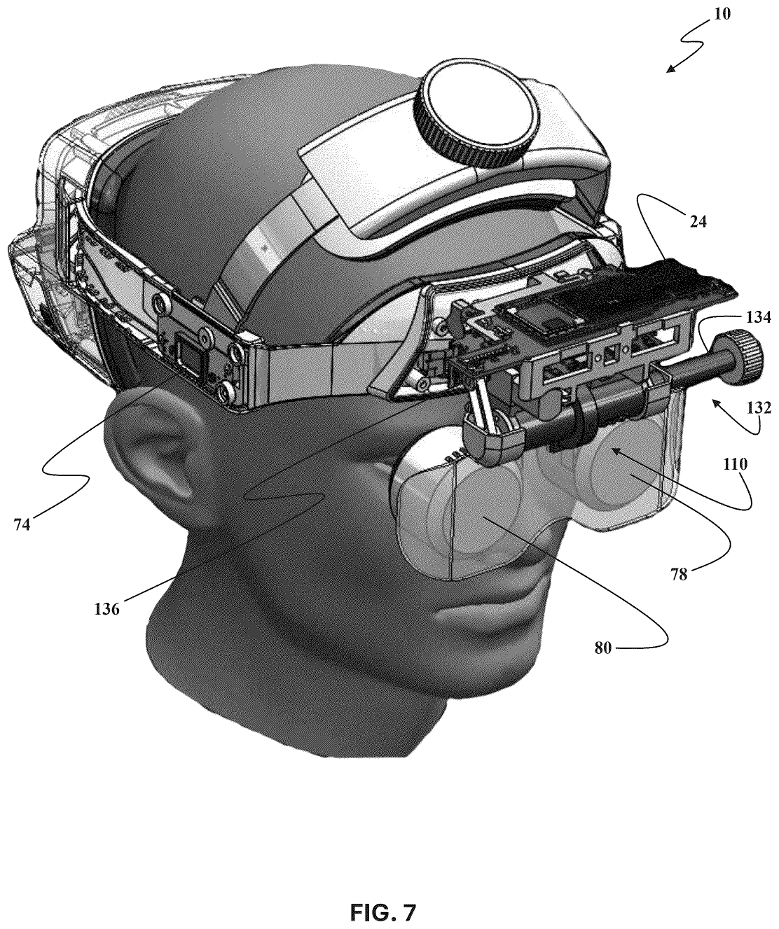

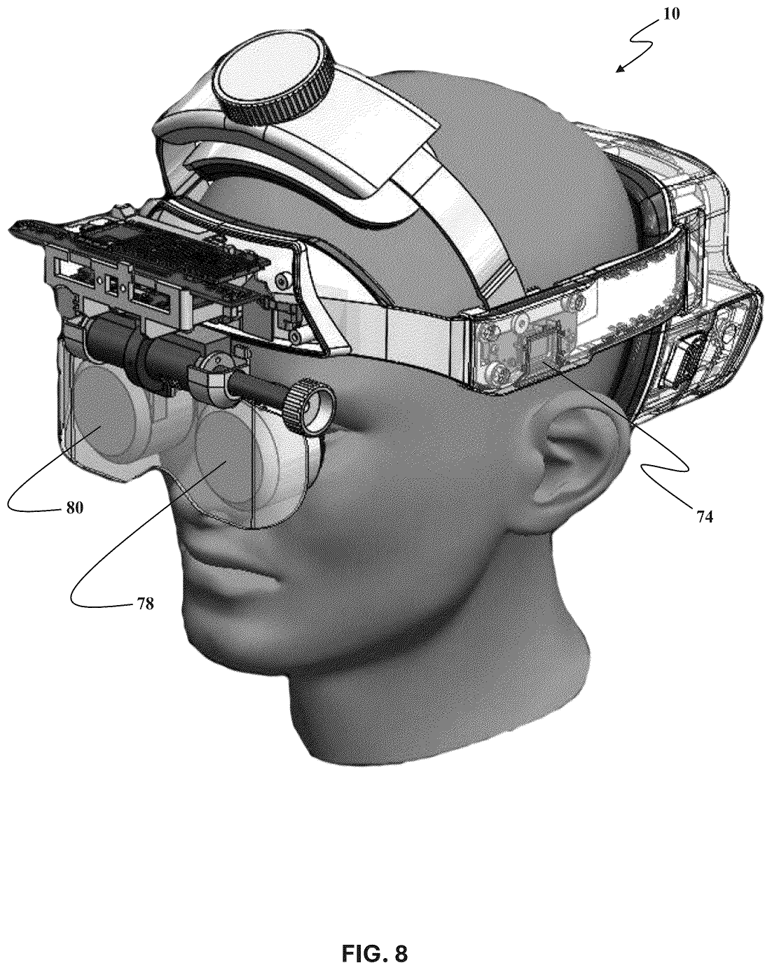

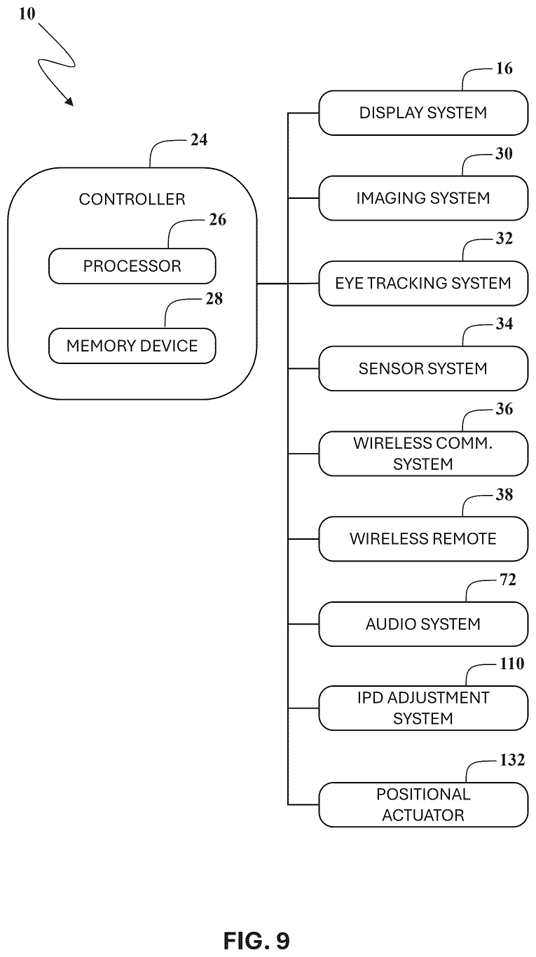

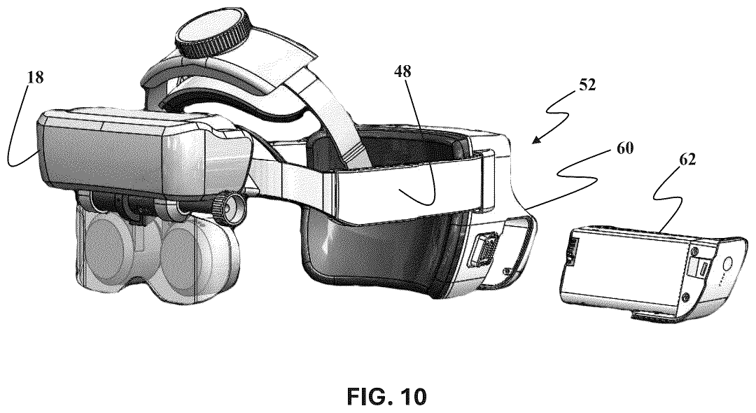

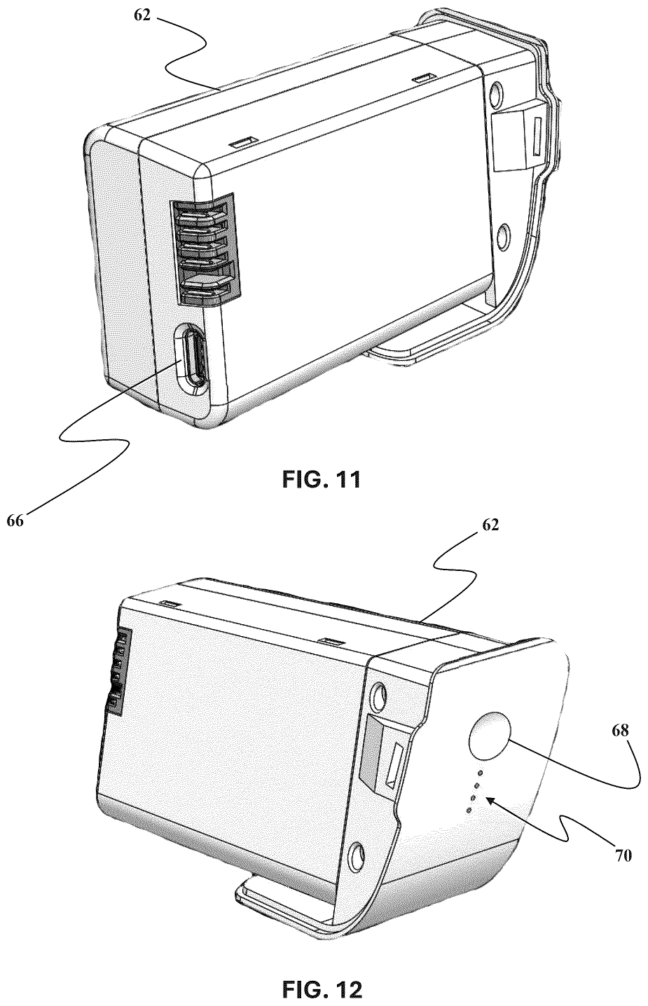

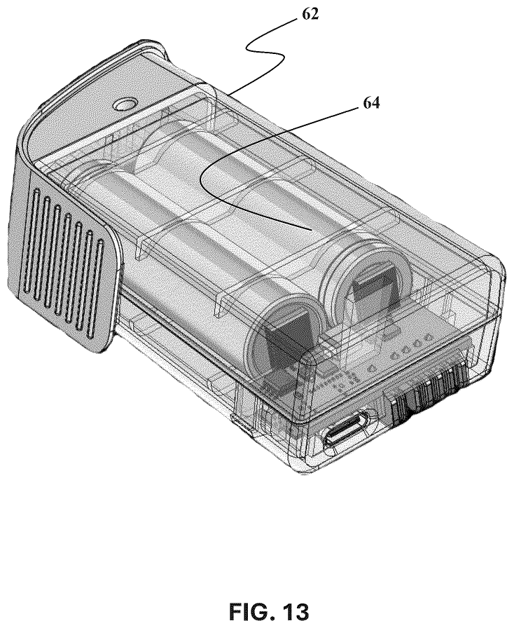

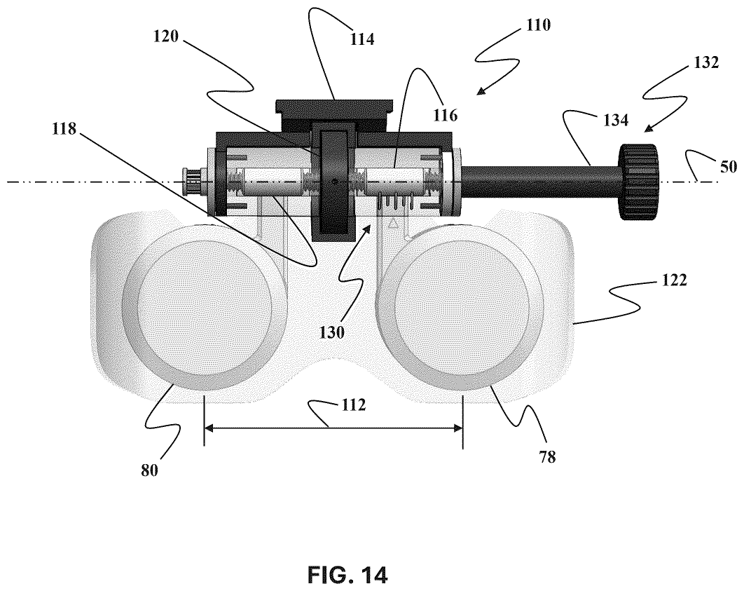

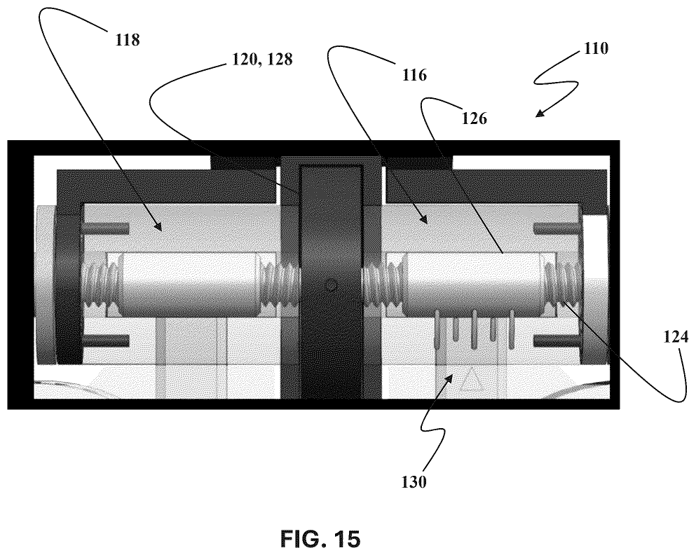

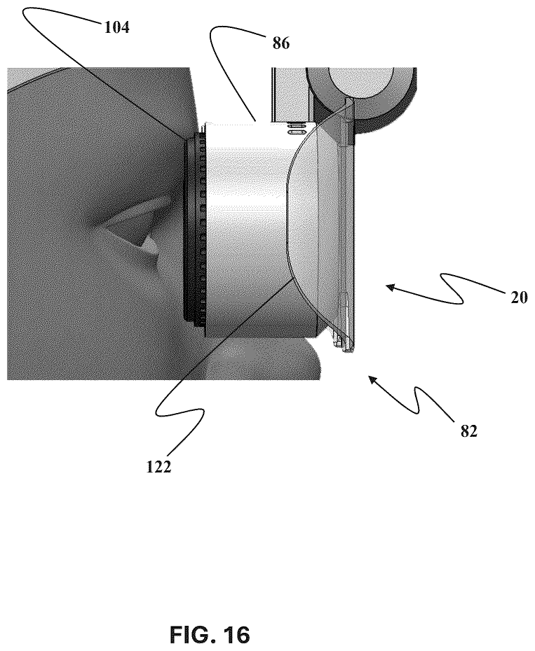

Referring to FIGS. 1-18, in the illustrated embodiment, the present invention includes an extended reality (XR) headset assembly 10 that includes a headset 12 that is adapted to be worn by a user 14 and a display system 16 mounted to the headset 12 and configured to display a display screen including computer-generated images thereon. The display system 16 includes an imaging equipment housing 18 mounted to the headset 12, a pair of pancake lens assemblies 20 extending from a bottom outer surface 22 of the imaging equipment housing 18, and a controller 24 that is housed within the imaging equipment housing 18 and includes one or more processors 26 coupled to the pancake lens assemblies 20 and programmed to display computer-generated images on the pancake lens assemblies 20.

The controller 24 includes a memory device 28 for storing computer-executable instructions thereon, and one or more processors 26 programmed to execute the computer-executable instructions to perform algorithms for displaying computer-generated images on the display system 16 using image data received from an imaging system 30. In some embodiments, the XR headset assembly 10 may also include an eye tracking system 32 mounted to the headset 12 and coupled to the controller 24 for use in tracking the user's eye movement and determining position of the user's gaze, a sensor system 34 mounted to the headset 12 and coupled to the controller 24 for determining a position and/or movement of the user's head and/or the headset 12, wireless communication system 36, and a wireless hand-held remote 38 that wirelessly communicates with the controller 24. The wireless communication system 36 may include, for example, a cellular antenna, a radio antenna, WiFi, Bluetooth and/or Bluetooth Low Energy, and/or any wireless communication system 36 suitable to enable the XR headset assembly 10 to function as described herein. The imaging system 30 may be, for example, a camera sensor mounted to the headset, a digital microscope wirelessly communicating with the controller 24 via the wireless communication system 36, and/or any suitable imaging system capable of capturing video images and transmitting capture video images data to the controller 24 for use in displaying computer-generated images on the pancake lens assemblies 20 using image data received from the imaging system 30.

The headset 12 includes a support frame 40 that extends between a forward portion 42 and a rear portion 44 along a longitudinal axis 46. The support frame 40 includes a pair of opposing support arms 48 extending along the longitudinal axis 46 and spaced along a transverse axis 50 perpendicular to the longitudinal axis 46. A rechargeable protected battery pack assembly 52 is coupled to the support arms 48 at the rear portion 44 of the support frame 40 and is positioned adjacent the back of the user's head. A curved upper support assembly 54 extends between the support arms 48 and is adapted to contact a top portion of the user's head to facilitate supporting the XR headset 12 from the user's head. The curved upper support assembly 54 includes an adjustable-length strap assembly 56 and a positioning pad 58 coupled to adjustable-length strap assembly 56 and contacting the user's head when worn by the user 14.

The rechargeable protected battery pack assembly 52 provides electrical power to various components of the XR headset assembly 10. The rechargeable protected battery pack assembly 52 includes a battery support housing 60 coupled to the support arms 48 at the rear portion 44 of the support frame 40 and positioned adjacent the back of the user's head, and a removable rechargeable battery pack 62 stored within the battery support housing 60. The removable rechargeable battery pack 62 contains one or more rechargeable batteries 64 and includes a USB-C charging port 66, a charge indicator touchpad 68, and a plurality of charge level LED indicators 70 for indicating a remaining battery charge of the rechargeable batteries 64 when a user presses the charge indicator touchpad 68.

The headset 12 may also include an audio system 72 including a pair of speakers 74 mounted to the opposing support arms 48 and a plurality of microphones 76 mounted to the bottom outer surface 22 of the imaging equipment housing 18. The controller 24 is operatively coupled to the audio system 72 to enable a user to operate the display system 16 using voice commands.

The display system 16 is coupled to the support frame 40 and includes the imaging equipment housing 18 coupled to the forward portion 42 of the support frame 40 and positioned adjacent a forehead of the user. The pair of pancake lens assemblies 20 extend from the bottom outer surface of the imaging equipment housing 18 and are spaced along the transverse axis 50. The pair of pancake lens assemblies 20 include a left-eye pancake lens assembly 78 positioned adjacent a left eye of the user and a right-eye pancake lens assembly 80 positioned adjacent a right eye of the user.

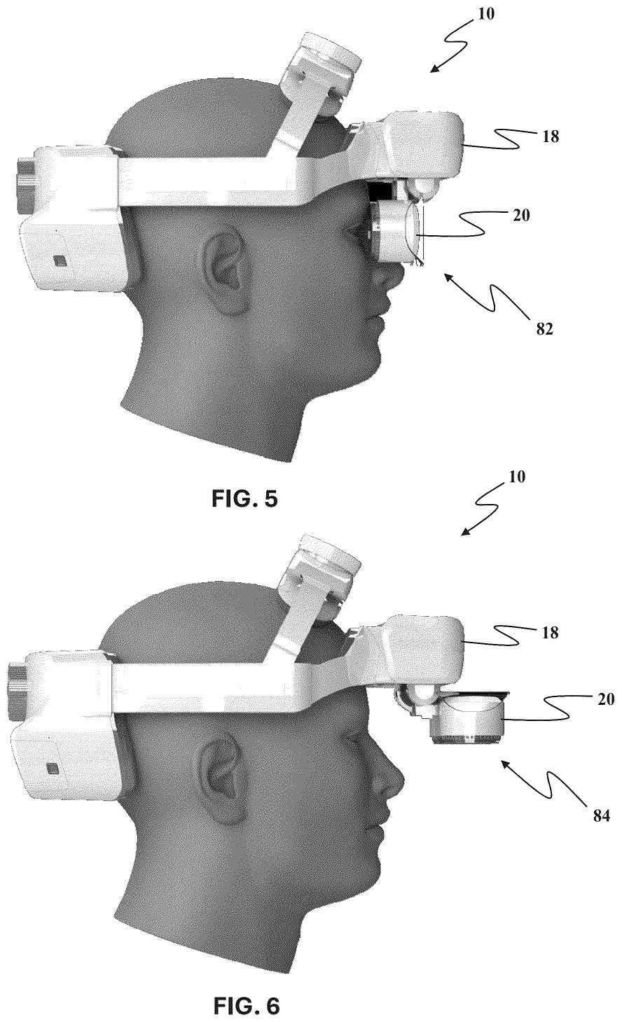

Each pancake lens assembly 20 is pivotably coupled to the support frame 40 to tilt-up and be positionable between a deployed position 82 (shown in FIG. 5) with the pancake lens assemblies 20 positioned in front of the user's eyes, and a stowed position 84 (shown in FIG. 6) with the pancake lens assemblies 20 pivoted to a position above the user's eyes. Each pancake lens assembly 20 includes a lens housing 86 containing an image generator 88 and an imaging lens assembly 90 positioned between the image generator 88 and the user's eye along an optical axis 92. For example, the lens housing 86 may contain the image generator 88 positioned at a first end 94 and the imaging lens assembly 90 positioned near a second end 96 of the lens housing 86 along the optical axis 92. In the deployed position 82, the imaging lens assembly 90 is positioned between the image generator 88 and the user's eye along the optical axis 92.

The imaging lens assembly 90 includes a diopter adjustment lens group 98 that is movable along the optical axis 92 and a pair 100 of opposing stationary singlet lenses 102 positioned between the diopter adjustment lens group 98 and the image generator 88. For example, the imaging lens assembly 90 may include a barrel cam mechanism 104 that is coupled to the diopter adjustment lens group 98 and is configured to move the diopter adjustment lens group 98 along the optical axis 92. The barrel cam mechanism 104 provides a customizable eye-specific viewing distance that enables users to tailor the viewing distance for each eye independently, which complements the fine focus adjustment already available in the imaging lens assembly 90 offering an additional layer of customization for optimal viewing comfort.

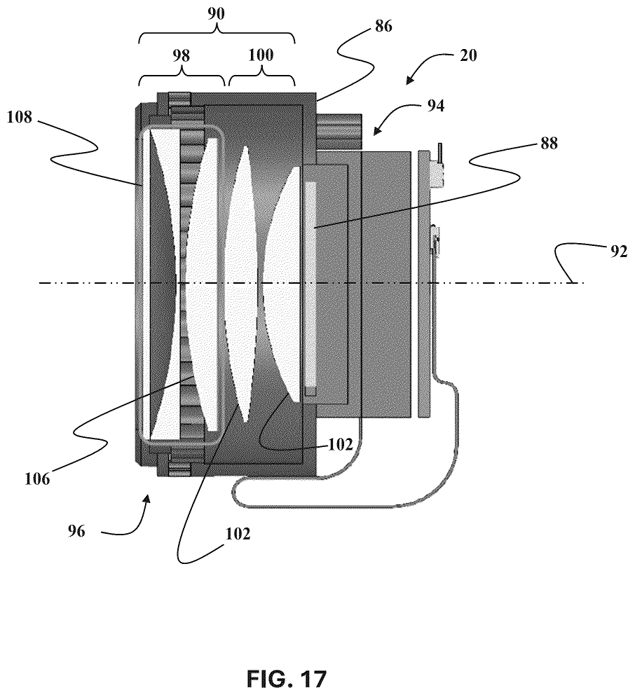

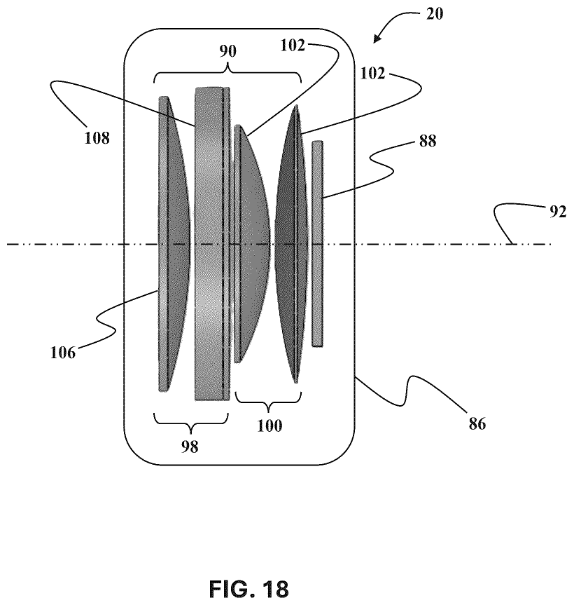

The diopter adjustment lens group 98 includes a singlet lens 106 and a doublet lens 108. In some embodiments, as shown in FIG. 17, the singlet lens 106 is positioned between the doublet lens 108 and the pair 100 of opposing stationary singlet lenses 102 along the optical axis 92. In other embodiments, as shown in FIG. 18, the doublet lens 108 is positioned between the singlet lens 106 and the pair 100 of opposing stationary singlet lenses 102 along the optical axis 92.

The display system 16 may also include an inter-pupil distance (IPD) adjustment system 110 that is coupled to the left-eye and right-eye pancake lens assemblies 78, 80 and is configured to adjust the distance 112 between the left-eye and right-eye pancake lens assemblies 78, 80 along the transverse axis 50 to facilitate accommodating the IPD of the user. For example, the IPD adjustment system 110 may be configured to adjust the inter-pupil distance between about 55 mm to 73 mm. The IPD adjustment system 110 includes a stationary center support 114 mounted to the headset support frame 40, a left transport apparatus 116 slideably mounted to the stationary center support 114 and coupled to the left-eye pancake lens assembly 78 for supporting the left-eye pancake lens assembly 78 from the stationary center support 114, and a right transport apparatus 118 slideably mounted to the stationary center support 114 and coupled to the right-eye pancake lens assembly 80 for supporting the right-eye pancake lens assembly 80 from the stationary center support 114. The IPD adjustment system 110 may also include an IPD actuator 120 that is configured to selectively move the left transport apparatus 116 and the right transport apparatus 118 along the transverse axis 50 to adjust an inter-pupil spacing between the left-eye pancake lens assembly 78 and the right-eye pancake lens assembly 80. The display system 16 may also include a detachable visor assembly 122 that is removably coupled to the stationary center support 114.

Each transport apparatus 116, 118 includes a dual thread lead screw 124 that is rotatably coupled to the stationary center support 114, and a display carrier 126 that is coupled to the corresponding pancake lens assembly 20 and to the dual thread lead screw 124 such that a rotation of the dual thread lead screw 124 causes a movement of the display carrier 126 and the corresponding pancake lens assembly 20 along the transverse axis 50. The IPD actuator 120 may include an IPD adjustment dial 128 that is coupled to each dual thread lead screw 124 such that a rotation of the IPD adjustment dial 128 causes a corresponding rotation of each dual thread lead screw 124 to enable a user to rotate the IPD adjustment dial 128 to adjust the distance 112 between the left-eye pancake lens assembly 78 and the right-eye pancake lens assembly 80. In some embodiments, the controller 24 may be operably coupled to the IPD actuator 120 to adjust the inter-pupil distance based on commands received from the user via the audio system 72 and/or sensor system 34. The IPD adjustment system 110 may also include an IPD distance indicator 130 affixed to an outer surface of the display carrier 126 indicating a current inter-pupil distance of the IPD adjustment system 110.

In some embodiments, the display system 16 may also include hybrid hand-auto system including a positional actuator 132 including a handle 134 that is coupled to each display carrier 126 and is configured to rotate each display carrier 126 and corresponding pancake lens assembly 20 between the deployed position 82 and the stowed position 84. The positional actuator 132 may also include a motor 136 that is coupled to the handle 134 for rotating the handle 134. The controller 24 may be operably coupled to the motor 136 to adjust the position of the pancake lens assemblies 20 between the deployed position 82 and the stowed position 84 based on commands received from the user via audio system 72 and/or sensor system 34.

The present invention is also directed to a method of assembling the XR headset assembly 10. The method includes providing a headset 12 adapted to be worn by a user and including a support frame 40 including a pair of opposing support arms 48 extending along the longitudinal axis 46 and spaced along the transverse axis 50, coupling the imaging equipment housing 18 to the forward portion 42 of the support frame 40, and pivotable coupling the pair of pancake lens assemblies 20 from the bottom outer surface of the imaging equipment housing 18.

While the devices and methods have been described with a certain degree of particularity, it is to be noted that many modifications may be made in the details of the construction and the arrangement of the devices and components without departing from the spirit and scope of this disclosure. It is understood that the devices and methods are not limited to the embodiments set forth herein for purposes of exemplification. It will be apparent to one having ordinary skill in the art that the specific detail need not be employed to practice according to the present disclosure. In other instances, well-known materials or methods have not been described in detail in order to avoid obscuring the present disclosure.

A controller, computing device, or computer, such as described herein, includes at least one or more processors or processing units and a system memory. The controller typically also includes at least some form of computer readable media. By way of example and not limitation, computer readable media may include computer storage media and communication media. Computer storage media may include volatile and nonvolatile, removable and non-removable media implemented in any method or technology that enables storage of information, such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, a processor, as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Other aspects and features of the present invention can be obtained from a study of the drawings, the disclosure, and the appended claims. The invention may be practiced otherwise than as specifically described within the scope of the appended claims. It should also be noted, that the steps and/or functions listed within the appended claims, notwithstanding the order of which steps and/or functions are listed therein, are not limited to any specific order of operation.

Although specific features of various embodiments of the invention may be shown in some drawings and not in others, this is for convenience only. In accordance with the principles of the invention, any feature of a drawing may be referenced and/or claimed in combination with any feature of any other drawing.

The invention has been described in detail with particular reference to a presently preferred embodiment, but it will be understood that variations and modifications can be effected within the spirit and scope of the disclosure. The presently disclosed embodiments are therefore considered in all respects to be illustrative and not restrictive. The scope of the invention is indicated by any appended claims, and all changes that come within the meaning and range of equivalents thereof are intended to be embraced therein.

What is claimed is:

1. An extended reality (XR) headset assembly comprising:
a headset adapted to be worn by a user and including:
a support frame including a pair of opposing support arms extending along a longitudinal axis and spaced along a transverse axis perpendicular to the longitudinal axis; and
a display system coupled to the support frame and including:
an imaging equipment housing coupled to a forward portion of the support frame and positioned adjacent a forehead of the user;
a pair of pancake lens assemblies extending from a bottom outer surface of the imaging equipment housing and spaced along the transverse axis including a left-eye pancake lens assembly positioned adjacent a left eye of the user and a right-eye pancake lens assembly positioned adjacent a right eye of the user, each pancake lens assembly is pivotably coupled to the support frame and includes a lens housing containing an image generator and an imaging lens assembly positioned between the image generator and the user's eye along an optical axis; and
a controller housed within the imaging equipment housing and including one or more processors coupled to the pancake lens assemblies and programmed to display computer-generated images on the pancake lens assemblies.

2. The XR headset assembly of claim 1, wherein the imaging lens assembly includes:
a diopter adjustment lens group movable along the optical axis; and
an opposing pair of stationary singlet lenses positioned between the diopter adjustment lens group and the image generator.

3. The XR headset assembly of claim 2, wherein the imaging lens assembly includes a barrel cam mechanism coupled to the diopter adjustment lens group and configured to move the diopter adjustment lens group along the optical axis.

4. The XR headset assembly of claim 2, wherein the diopter adjustment lens group includes a singlet lens and a doublet lens.

5. The XR headset assembly of claim 4, wherein the diopter adjustment lens group includes the singlet lens positioned between the doublet lens and the pair of opposing stationary singlet lenses along the optical axis.

6. The XR headset assembly of claim 4, wherein the diopter adjustment lens group includes the doublet lens positioned between the singlet lens and the pair of opposing stationary singlet lenses along the optical axis.

7. The XR headset assembly of claim 1, wherein the display system includes:
an inter-pupil distance (IPD) adjustment system including:
a stationary center support mounted to the headset support frame;
a left transport apparatus slideably mounted to the stationary center support and coupled to the left-eye pancake lens assembly for supporting the left-eye pancake lens assembly from the stationary center support;
a right transport apparatus slideably mounted to the stationary center support and coupled to the right-eye pancake lens assembly for supporting the right-eye pancake lens assembly from the stationary center support; and
an IPD actuator configured to selectively move the left transport apparatus and the right transport apparatus along the transverse axis to adjust an inter-pupil spacing between the left-eye pancake lens assembly and the right-eye pancake lens assembly.

8. The XR headset assembly of claim 7, wherein each transport apparatus includes:
a dual thread lead screw rotatably coupled to the stationary center support; and
a display carrier coupled to a corresponding pancake lens assembly and the dual thread lead screw such that a rotation of the dual thread lead screw causes a movement of the display carrier and the corresponding pancake lens assembly along the transverse axis.

9. The XR headset assembly of claim 8, wherein the IPD adjustment system includes
an IPD distance indicator affixed to an outer surface of the display carrier indicating a current inter-pupil distance of the IPD adjustment system.

10. The XR headset assembly of claim 8, wherein the display system includes a positional actuator coupled to each display carrier and configured to rotate each display carrier and corresponding pancake lens assembly between a deployed position with the pancake lens assemblies positioned in front of the user's eyes, and a stowed position with the pancake lens assemblies pivoted to a position above the user's eyes.

11. The XR headset assembly of claim 7, wherein the display system includes a detachable visor assembly removably coupled to the stationary center support.

12. The XR headset assembly of claim 1, further comprising:
an audio system including:
a pair of speakers mounted to the opposing support arms; and
a plurality of microphones mounted to the bottom outer surface of the imaging equipment housing.

13. The XR headset assembly of claim 1, further comprising:
a rechargeable protected battery pack assembly coupled to the support arms at a rear portion of the support frame and positioned adjacent the back of the user's head.

14. A display system for use with an extended reality (XR) headset assembly including a headset adapted to be worn by a user and including a support frame including a pair of opposing support arms extending along a longitudinal axis and spaced along a transverse axis perpendicular to the longitudinal axis, the display system comprising:
an imaging equipment housing coupled to a forward portion of the support frame and positioned adjacent a forehead of the user;
a pair of pancake lens assemblies extending from a bottom outer surface of the imaging equipment housing and spaced along the transverse axis including a left-eye pancake lens assembly positioned adjacent a left eye of the user and a right-eye pancake lens assembly positioned adjacent a right eye of the user, each pancake lens assembly is pivotably coupled to the support frame and includes a lens housing containing an image generator and an imaging lens assembly positioned between the image generator and the user's eye along an optical axis; and
a controller housed within the imaging equipment housing and including one or more processors coupled to the pancake lens assemblies and programmed to display computer-generated images on the pancake lens assemblies.

15. The display system of claim 14, wherein the imaging lens assembly includes:
a diopter adjustment lens group movable along the optical axis;
an opposing pair of stationary singlet lenses positioned between the diopter adjustment lens group and the image generator; and
a barrel cam mechanism coupled to the diopter adjustment lens group and configured to move the diopter adjustment lens group along the optical axis.

16. The display system of claim 15, wherein the diopter adjustment lens group includes a singlet lens and a doublet lens.

17. The display system of claim 16, wherein the diopter adjustment lens group includes the singlet lens positioned between the doublet lens and the pair of opposing stationary singlet lenses along the optical axis.

18. The display system of claim 16, wherein the diopter adjustment lens group includes the doublet lens positioned between the singlet lens and the pair of opposing stationary singlet lenses along the optical axis.

19. The display system of claim 14, further comprising:
an inter-pupil distance (IPD) adjustment system including:
a stationary center support mounted to the headset support frame;
a left transport apparatus slideably mounted to the stationary center support and coupled to the left-eye pancake lens assembly for supporting the left-eye pancake lens assembly from the stationary center support;
a right transport apparatus slideably mounted to the stationary center support and coupled to the right-eye pancake lens assembly for supporting the right-eye pancake lens assembly from the stationary center support;
wherein each transport apparatus includes:
a dual thread lead screw rotatably coupled to the stationary center support; and
a display carrier coupled to a corresponding pancake lens assembly and the dual thread lead screw such that a rotation of the dual thread lead screw causes a movement of the display carrier and the corresponding pancake lens assembly along the transverse axis;
an IPD distance indicator affixed to an outer surface of at least one display carrier indicating a current inter-pupil distance of the IPD adjustment system; and
an IPD actuator configured to selectively move the left transport apparatus and the right transport apparatus along the transverse axis to adjust an inter-pupil spacing between the left-eye pancake lens assembly and the right-eye pancake lens assembly.

20. The display system of claim 19, further comprising:
a positional actuator coupled to each display carrier and configured to rotate each display carrier and corresponding pancake lens assembly between a deployed position with the pancake lens assemblies positioned in front of the user's eyes, and a stowed position with the pancake lens assemblies pivoted to a position above the user's eyes.
